(19) United States
(12) Patent Application Publication
(10) Pub. No.: US 2003/0097346 A1
(43) Pub. Date: May 22, 2003

(54) Control of franking machine from office programs

(76) Inventor: Peter Heimann, Bern (CH)

Correspondence Address: Geza C. Ziegler, Jr., Perman & Green, LLP, 425 Post Road, Fairfield, CT, 06430, US

(21) Appl. No.: 10/157,642

(22) Filed: May 28, 2002

Related U.S. Application Data
(60) Provisional application No. 60/332,079, filed on Nov. 21, 2001.

(51) Int. Cl. G06F 17/00

(52) U.S. Cl. 705/402; 705/408

(57) ABSTRACT

A method for controlling at least one franking machine coupled to a computing device. The method includes opening a document application program and initiating one of a saved sequence of control commands linked to a franking machine control library. The library includes a plurality of commands related to the operation and control of the franking machine. An operation can be performed at the franking machine corresponding to the command sent from the application program.

### CROSS-REFERENCE TO RELATED APPLICATIONS

This application claims priority of U.S. Provisional Patent Application Serial No. 60/332,079 filed on Nov. 21, 2001.

### BACKGROUND OF THE INVENTION

1. Field of the Invention

The present invention is generally related to the control of franking machines, and in particular to the control of franking machines using command sequences in an application program.

2. Brief Description of Related Developments

In many businesses, one or more franking machines are used in a mailroom, or several are used in mailrooms in different locations. If such franking machine or machines operate autonomously, there is virtually no easy way to exercise management control, so that it is possible to determine how postage is being used. While in principle, it is possible to keep a postal log stating the purpose of each piece of mail being franked, this takes up an enormous amount of time, is subject to accidental or intentional errors, and provides only minimal information.

### SUMMARY OF THE INVENTION

The present invention is directed to a method for controlling at least one franking machine coupled to a computing device. In one embodiment the method includes opening a document application program and initiating one of a saved sequence of control commands linked to a franking machine control library. The library includes a plurality of commands related to the operation and control of the franking machine. An operation is performed at the franking machine corresponding to the command sent from the application program.

In one aspect, the present invention is directed to a system for controlling at least one franking machine. In one embodiment the system comprises a computing device coupled to the at least one franking machine and an application program residing on the computing device. The application program is adapted to allow a user to launch at least one saved sequence of commands that are linked to a franking machine control library in order to receive data from each franking machine and control a function of each franking machine.

In another aspect, the present invention is directed to a computer program product. In one embodiment, the computer program comprises a computer useable medium having computer readable code means embodied therein for causing a computer to control an operation of a franking machine. The computer readable code means in the computer program product comprises computer readable program code means for causing a computer to open a document application program, computer readable program code means for causing a computer to execute a saved sequence of control commands linked to a franking machine control library based on a command inputted by a user and computer readable program code means for causing a computer to execute a function at the franking machine corresponding to the command inputted by the user.

In a further aspect, the present invention is directed to an article of manufacture. In one embodiment the article of manufacture comprises a computer useable medium having computer readable program code means embodied therein for causing a computer to control a franking machine from an office application. The computer readable code means in the article of manufacture comprises computer readable program code means for causing a computer to execute a sequence of control commands based on user generated input. The control commands adapted to execute a franking machines control function accessed from a franking machine control library. The article of manufacture also includes computer readable program code means for causing a computer to perform a function in the franking machine based upon the user input, wherein the franking machine is adapted to return data to the application responsive to the user input, and wherein the data is automatically uploaded into a document associated with the application.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention.

FIG. 2 illustrates one embodiment of a communications setup and protocol between the franking machine and computer of FIG. 1.

FIG. 3 illustrates one embodiment of a programming interface and architecture for the system of FIG. 1.

FIG. 4 is a flowchart of one embodiment of a method for controlling a franking machine in a system incorporating features of the present invention.

FIG. 5 is an illustration of data capture using an office application in a system incorporating features of the present invention.

FIG. 6 is an illustration of control of a franking machine from an office application in a system incorporating features of the present invention.

FIG. 7 is a block diagram of one embodiment of an apparatus that can be used to practice the present invention.

### DETAILED DESCRIPTION OF THE PREFERRED EMBODIMENT(S)

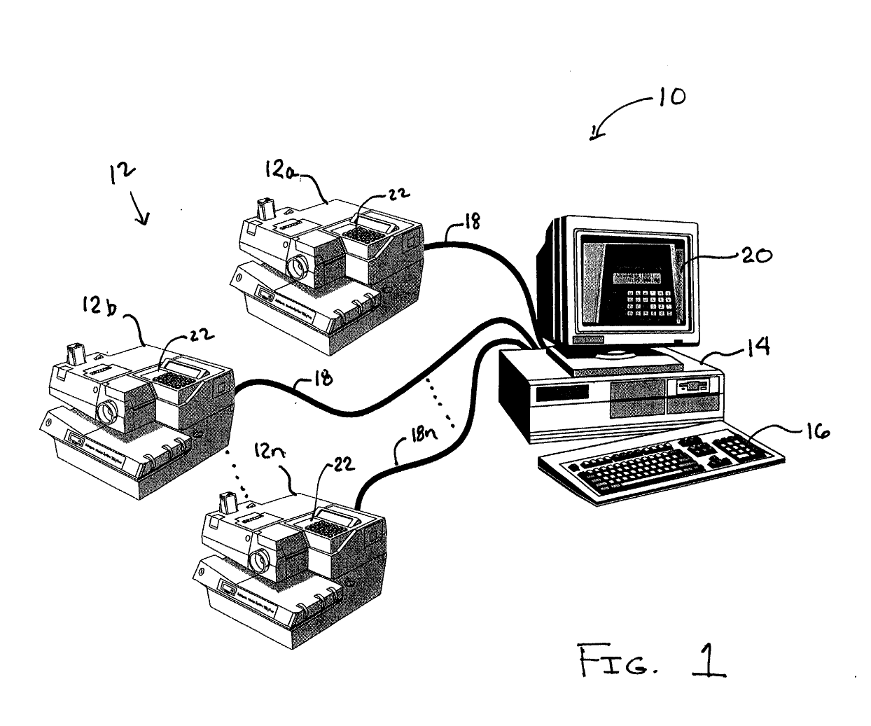

Referring to FIG. 1, a block diagram of a system 10 incorporating features of the present invention is illustrated. Although the present invention will be described with reference to the embodiments shown in the drawings, it should be understood that the present invention can be embodied in many alternate forms of embodiments. In addition, any suitable size, shape or type of elements or materials could be used.

The system 10 shown in FIG. 1 generally comprises at least one franking machine 12a and a computing device 14. The system 10 can include any number of different franking machines 12a to 12n, and the computing device 14 can be connected to one or more of the franking machines 12 through 12n. The computing device 14 is linked or connected to each franking machine 12 via a connection 18 and is adapted to control the operations of each franking machine as well as input and gather data. The connection 18 can comprise any suitable connection means, such as for example, a direct connection, a wireless connection, a modem, or an Internet connection. For example, in one embodiment the computing device 14 can be remotely located from each franking machine 12. Generally, any suitable or conventional means can be used to provide a communication link 18 or connection between the computing device and each franking machine.

The system 10 is generally adapted to allow a user to control and collect data and other information from one or more franking machines 12 using the computing device 14. The user can also control the functions of each franking machine 12 via the computing device 14. Control systems can be used to interface a franking with a computer system or device. One example of such a control system for a franking machine is described in U.S. patent application Ser. No. 09/888,935 filed on Jun. 26, 2001, the disclosure of which is incorporated herein by reference in its entirety. The computing device 14 could comprise a personal computer, a mainframe or any other computer associated with for example, business-type operations. In alternate embodiments, the system 10 can include any suitable components or devices that can allow an operator to control and/or obtain data from a franking machine. It is a feature of the present invention to enable a user to control and obtain information from each franking machine by the execution of a saved sequence of commands, also referred to herein as a macro or macros. A simple command to initiate a macro can be inputted by the user into the system 10 via the user input device 16. The macro can then generate a stored sequence of instructions or programs that execute different functions or processes with respect to the franking machine 12.

The franking machine 12 generally comprises a postage metering system. Each franking machine 12a-12n is adapted to print indicia on articles, such as for example mailpieces. Although the present invention will be described herein with reference to postage systems and postal indicia, it will be understood that the present invention can be applied to any system for generating indicia. An example of a proof of postage digital franking system is described in U.S. Pat. No. 6,009,417, the disclosure of which is incorporated herein by reference in its entirety.

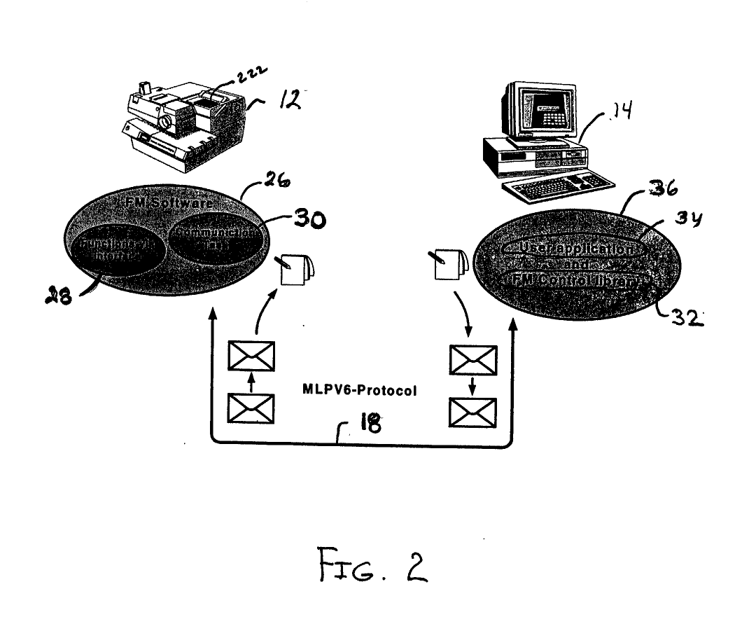

Referring to FIG. 2, each franking machine 12 has associated with it one or more software packages or a series of commands or instructions executable by a machine, represented schematically at 26, which includes a remote function package 28 and a communication task or module 30. The remote function package 28 generally provides a library of franking machine functions that can be controlled from or via the computer 14.

As shown in FIG. 2, the software package is represented schematically at 36. The software package 36 generally includes a user application 34 and a franking machine programming library 32, also referred to herein as a control library 32. Communication between the franking machine 12 and computer 14 occurs over the communication line 18, which in one embodiment can comprise an RS 232 communication line using, for example, the MLPV6 protocol, developed by Ascom Hasler Mailing Systems of Shelton, Conn. In alternate embodiments the communication line 18 comprises any suitable protocol for data communication at a desired transmission speed. Generally, the franking machine can define line speeds of at least 9600 bps although any suitable line speed can be defined. In one embodiment, an RS-232 line may be used conservatively at line speeds of 20 Kbps and with line lengths of up to 15 meters. In alternate embodiments, the franking machines can be controlled by any suitable interface and line speed.

The franking machine control library 32 is a library that is integrated into the user application 34. This library 32 allows accessing functions of the franking meter from the computer 14 in a comfortable and easy way. Normally, the functions of the franking machine must be accessed via a keypad 222 on the machine 12. The present invention offers the same functionality as is available at the franking meter keyboard 222. Thus, the entire franking meter user interface 222 can be simulated or rebuilt on computer 14 and adapted to a customer's needs without the need for direct access to each franking machine.

As noted above, the main task of the control library 32 is communication with the franking machine. In one embodiment, the MLPV6 protocol takes care of the complex and sensitive communication between the computer 14 and franking machine 12. Another important task of the control library 32 is providing an information wrapper. The information wrapping checks the data from the user and the machine and converts it into compatible values (e.g. money values). In addition, the control library 32 provides information not explicitly supplied by the franking meter, such as the availability of franking modes, that depend on the base software in the franking machine.

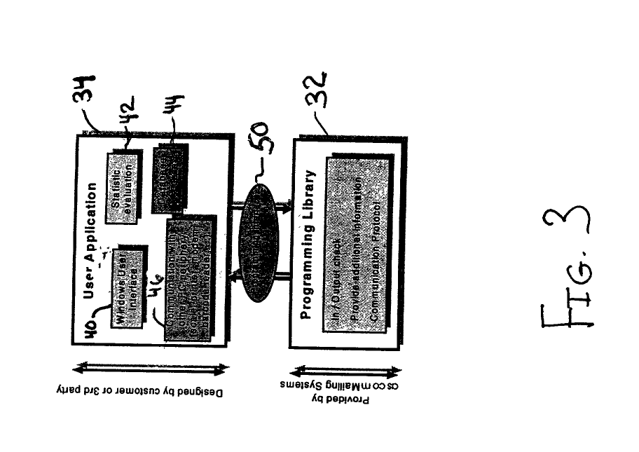

Referring to FIG. 3, some examples of possible modules with the user application 34 are a Windows® interface 40, a statistic evaluation module 42, a database access module 44, and a communication package 46 for communicating with other peripheral devices associated with computer 14 such as, for example, a postage scale, a printer, a modem or a barcode reader. In alternate embodiments, any suitable type of software module can be integrated into the user application. Generally, the peripheral devices can include any peripheral device that can be associated with the franking machine. It will be understood that user application 34 can be custom programmed by the user and that many variations on its contact and function are possible. For example, a statistical database may provide information as to customer mailing patterns and behaviors. An audit trail may be provided. Mailroom resources may be more efficiently scheduled, and budgets efficiently managed.

The user application 34 can be connected via a programming interface (com) 50 to the control or programming library 32. The control library 32 may include an input/output check, a source of additional information to a user of the library 32 and software for executing an appropriate communication protocol. The programming library can be programmed in a language such as, for example, Visual C++.

The control library 32 interfaces to a user application 34 by way of the programming interface 50. The programming interface 50 can take the form of a Component Object Model (COM) interface also known as ActiveX. COM is a quasi standard for the Windows environment. It allows accessing the library with almost any Windows programming language. Thus, any programming language can be extended with franking machine functions that are as easy to use as any built-in command of the programming language.

The control library 32 of FIG. 2 includes several objects. These objects include Connection, Configuration, Actions, Departments, and Statistics. Each one of these objects has properties, methods and events.

Each franking machine 12 can include a postal security device 22 that houses physically and cryptographically secure funds and associated accounting registers. The franking machine 12 and security device 22 provide for the interchange of data between a source of monetary funding, the tracking of the funds, a maintenance source and a printing source. The franking machine 12 and security device 22 allows a customer to apply indicia, such as postal indicia, in a secure manner.

As shown in FIG. 1, the franking machine or device 12 is interfaced to a computing device 14, such as for example a personal computer. The computing device 14 is generally adapted to send and receive data or instructions to any from each franking machine 12. This can include instructions for initializing each franking machine 12, generating indicia via any one of the franking machines 12 or replenishing funds. Generally any function of the franking machine 12 can be controlled by the computing device 14. The computing device 14 can also be adapted to extract data from each franking machine 12. This data can include for example, the amount of funds used or remaining, the values of the ascending or descending registers and statistical data related to the use of each franking machine.

Examples of application programs 34 that can be used in the present invention can include programs such as Microsoft™ Office, Word, Excel, Access or Visual Basic. In alternate embodiments, the application program can include any application program that provides the capability of generating and saving sequences of commands or keyboard strokes that can be stored and then recalled with a single command or keyboard stroke. It is a feature of the present invention to use a “macro” to access a franking machine control library to control one or more franking machines connected to the computing device 14. By using the macro functionality of the application program, the user can more easily access the functions of the franking machine control library 32.

For example, using a macro provides the user an easy way to create a report, or reports, of the state of each franking machine. Via the user input device 16, which can include for example a keyboard, mouse or tool screen, the user can launch a macro that retrieves for example, statistics related to each franking machine 12. Once retrieved, the statistics on data can be directly imported into a document or report 20 of the user application. It should be noted that the data that can be retrieved is not limited to statistics. Generally, any data that is stored in the franking machine can be retrieved by the computer. The data could include for example, configuration settings, statistical data, accounting data, service data or a list of counter or register values. If the user input device is a mouse, the user could click on an icon in a graphical user interface (“GUI”) of the computer 14 and read the desired data from the franking machine and past the data directly into a document, table or report. In this way, if the user is remotely located from the franking machine 12, the information can be easily accessed and viewed.

In addition to the reading of data from each franking machine 12, macros could be used to send different commands or sequences of instructions to one or more franking machines. For example, the execution of a selected macro could set a franking device 12 ready for franking. Examples of other possible command sequences could include ones to initialize that franking machine or configure the franking machine. The configuration can have an influence on the behavior of the franking machine. One example is to switch the “low credit warning” on or off. This decides whether the machine generates a warning message when the credit (descending register) drops below a defined value.

Some advantages of calling the FM control functions using macros are:

It is not necessary to write a special program apart from the macro. The application running the macro offers a whole environment with formatting and printing functions.

Macros can be created quickly and easily—virtually no development time.

The macro can be edited and adapted by anyone who understands macros. A dedicated program cannot be changed by the user as it comes as executable (EXE-file).

The output of the program can easily be reformatted and printed.

High flexibility (e.g. the macro could paste the data to the current cursor position where as a dedicated program would have a fixed output point on its user interface).

The following code is a sample macro written in Visual Basic for Applications (VBA) in MS Word 97. It reads the postal counters from the franking machine connected to a COM1 port and inserts the data at the current cursor position into the document.

Option Explicit

Public Con As FMCTRLLib.Connection

Sub FMControlGetCounters( )

'

'FMControlTest Makro V1.0

'Makro erstellt am 07.06/00 von Peter Heimann

Set Con=New FMCTRLLib.Connection

Dim Actions As New FMCTRLLib.FMActions

Dim Asc As Currency

Dim Desc As Currency

Dim Items As Long

Dim myRange As Range

On Error GoTo ErrorHandler

Con.Connect (“ComPort=1; PROTOCOL=MLPV6”)

Actions.ActiveConnection=Con

Actions.GetCounterValues Asc, Desc, Items

Set myRange=ActiveDocument.Range (Selection.Start, Selection.End)

With myRange

InsertAfter “Ascending:”

InsertAfter Str (Asc)

InsertParagraphAfter

InsertAfter “Descending:”

InsertAfter Str (Desc)

InsertParagraphAfter

InsertAfter “Items:”

InsertAFter Str (Items)

InsertParagraphAfter End With

Set Actions=Nothing

Con.Disconnect

Set Con=Nothing

Exit Sub

ErrorHandler: MsgBox (“Exception:”+Chr(13)+“Error Nr:”+Str (Err. Number−vbObjectError)+Chr (13)+“Description:”+Err.Description+Chr (13)+“Source:”+Err.Source)

Set Actions=Nothing

Con.Disconnect

Set Con=Nothing

End Sub

This is the output of the above sample macro:

Ascending: 826

Descending: 3860

Items: 1255

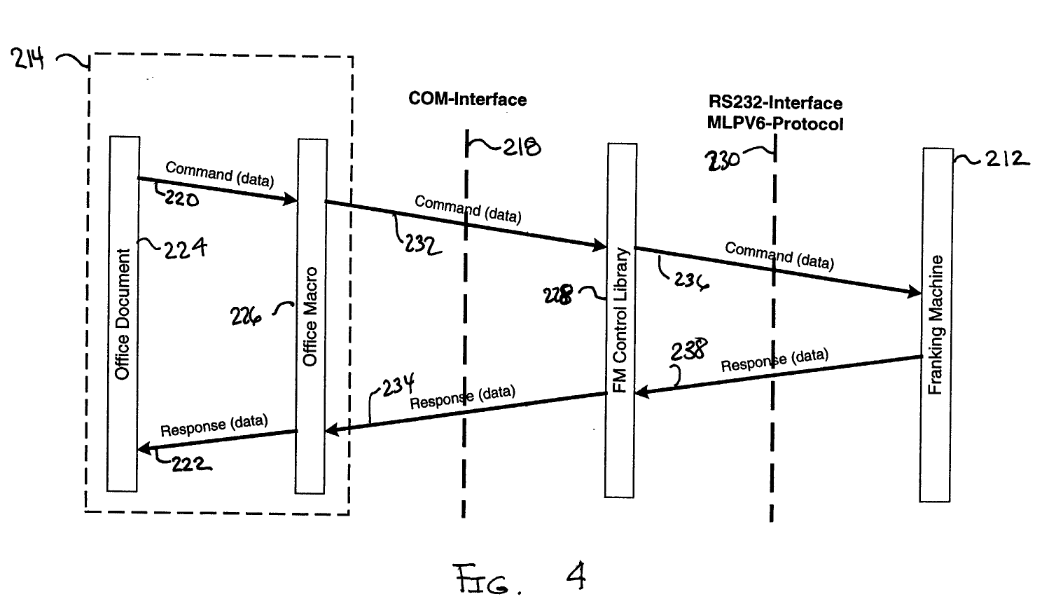

One embodiment of a control-message flow chart for controlling one or more franking machines 212 from an office application 214 is illustrated in FIG. 4. As shown in FIG. 4, the application 214 communicates to the franking machine or machines 212 via a communication interface 218. The communication interface 218 also referred to as “Com-Interface” can comprise a component object model that is adapted to transmit command data 220 to the franking machine 212 and transmit response data 222 from the franking machine 212 to the application 214.

The application 214 generally comprises an office application that supports the Com-Interface 218, such as for example, MS Word™, MS Excel™, or MS Access. The office document 224 is opened and at least one command 220 is generated. The command 220 is generally a command corresponding to one of the functions provide by the franking machine control library. There can be more than one command that is called generated by the application. One command can start the macro 226. The macro 226 can then contain one or more commands that correspond to those provided by the library.

The command 220 executes or launches a macro 226 that corresponds to the desired functionality. The macro 226 in turn generates a command sequence 232 that is transmitted to the FM control library 228 via the Com-Interface 218. The corresponding function is activated in the FM control library 228 and the appropriate command 236 is issued to the franking machine 212. The data or response 238 is returned from the franking machine 212 and processed back to the application 214, where it can be presented in a suitable format, such as the document 224.

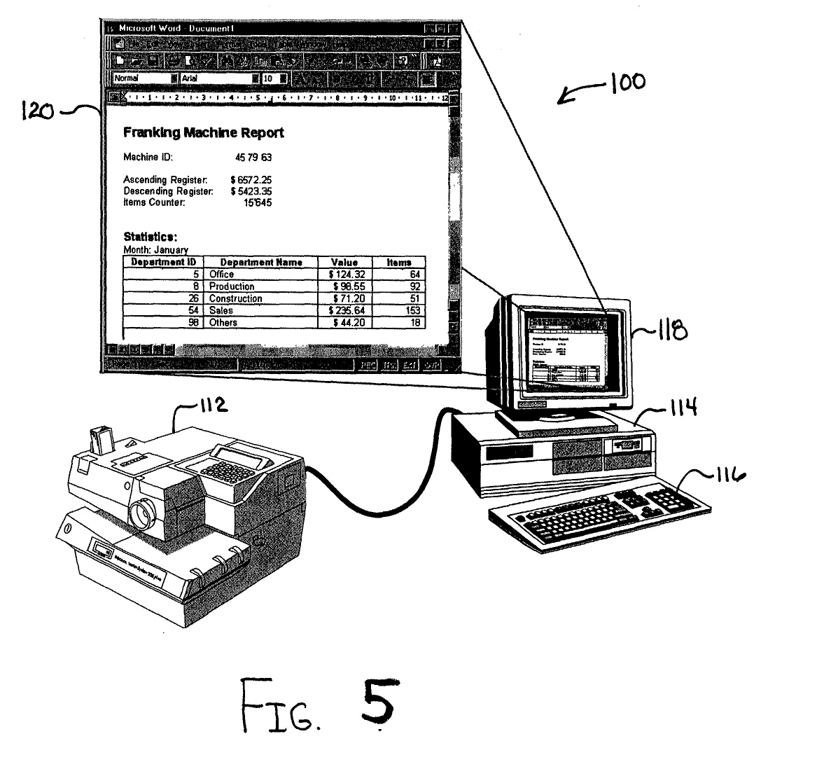

Referring to FIG. 5, a system 100 incorporating features of the present invention is illustrated that is adapted to capture data from a franking machine 112. A user can input a command, or initialize a macro, via the keyboard 116 of the computer 114. The keyboard 116 could also comprise any suitable device that can generate keyboard like commands, other than including a keyboard. In this example, a command is entered to generate a statistical report related to the use of the franking machine 112. After the user launches a macro adapted to generate the statistical report, the statistical data is read directly from the franking machine 112. The data is retrieved from the franking machine 112 and can be for example, automatically inserted into an office document 120 adapted to display the data in a desired format. The document 120 or report can be displayed on the display 118, or printed out. Alternatively, any suitable means of display can be used. The example illustrated in FIG. 5 shows a statistics report 120 that is generated in Microsoft Word™. The data is read and the report is generated automatically.

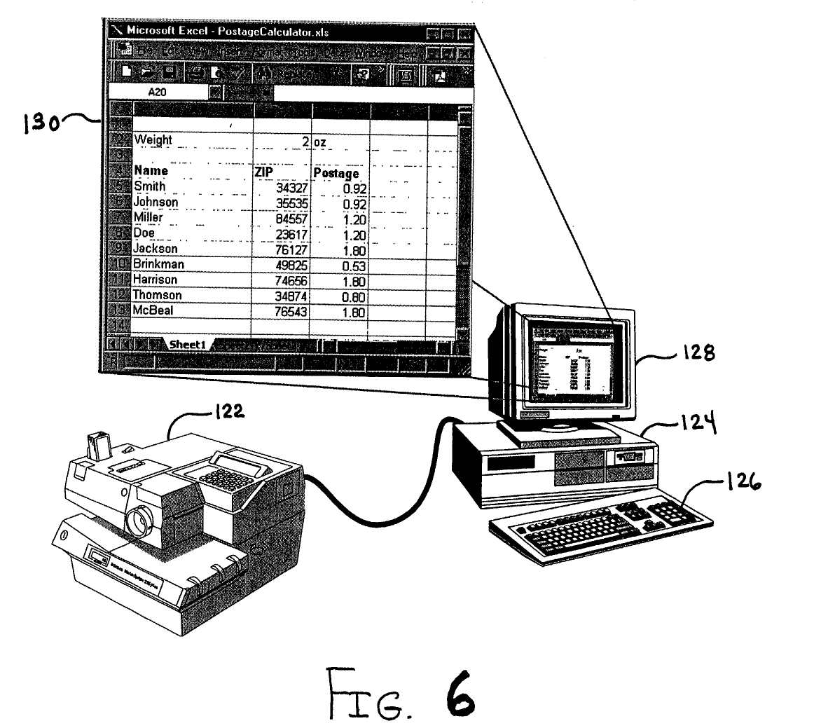

FIG. 6 illustrates another example of controlling a franking machine 122 via macros from an office application. In this example, a postage calculator program can generate a Microsoft Excel™ spreadsheet that is used to calculate the needed postage for sending mail pieces to different people. The report 130, can be part of a “postage calculation” function of the control library. After the calculations are complete, the different postage values are transmitted to the franking machine 122. The franking machine 122 can then frank each mail piece accordingly.

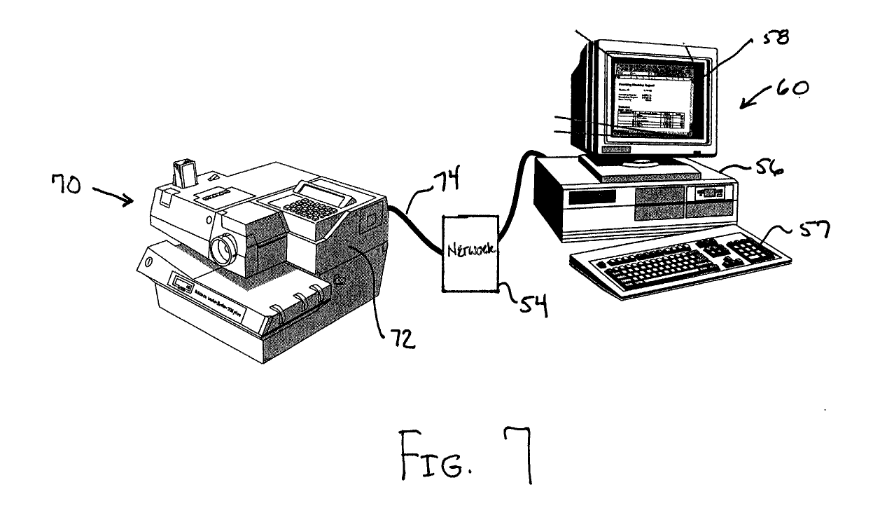

The present invention may also include software and computer programs incorporating the process steps and instructions described above that are executed in different computers. FIG. 7 is a block diagram of one embodiment of a typical apparatus incorporating features of the present invention that may be used to practice the present invention. As shown, a computer system 60 may be linked to one or more franking machines or systems 70, such that the systems 60 and 70 are capable of sending information to each other and receiving information from each other. Franking machine 70 could also include a computing device 72. In one embodiment, computer system 60 could include a server computer adapted to communicate with a network 54, such as for example, the Internet. Systems 60 and 70 can be linked together in any conventional manner including a modem, hard wire connection, or fiber optic link. Generally, information can be made available to both computer systems 60 and 70 using a communication protocol typically sent over a communication channel 74 or through a dial-up connection on ISDN line. Systems 60 and 70 are generally adapted to utilize program storage devices embodying machine readable program source code which is adapted to cause computers 60 and 70 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Systems 60 and 70 may also include a microprocessor for executing stored programs. Computer 60 may include a data storage device 56 on its program storage device for the storage of information and data. The computer program or software incorporating the processes and method steps incorporating features of the present invention may be stored in one or more computers 60 and 70 on an otherwise conventional program storage device. In one embodiment, computer 60 may include a user interface 57, and a display interface 58 from which features of the present invention can be accessed. The user interface 57 and the display interface 58 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for controlling at least one franking machine coupled to a computing device, the method comprising the steps of:
opening a document application program;
initiating at least one of a saved sequence of control commands linked to a franking machine control library, wherein the library includes a plurality of commands related to the operation and control of the franking machine; and
performing an operation at the franking machine corresponding to the control command sent from the application program.

2. The method of claim 1 wherein the step of initiating a control command further comprises the step of calling up a macro in the application program, the macro being adapted to execute at least one command associated with the franking machine control program.

3. The method of claim 1 wherein the franking machine is connected to a communications port of the computing device, and the control command includes a command to read a content of a postal counter in the franking machine and to insert the content at a current cursor position in a document of the document application.

4. The method of claim 1 wherein the control command includes a command to retrieve a list of all counter values for each franking machine associated with the computing device, and insert the list of counter values into a data report controlled by the application program.

5. The method of claim 1 wherein the control command includes a command to retrieve data stored in the franking machine.

6. The method of claim 6 wherein the retrieved data is configuration settings, statistical data, accounting data or service data.

7. The method of claim 1 wherein the application program provides a graphical user interface on the computing device and wherein an activation of a display icon on the graphical user interface sends a command to the control library and causes the control library to issue a command to read data from the franking machine and past the data to a document created by the application program.

8. The method of claim 1 wherein at least one of the saved sequence of commands automatically generates a report on a state of the franking machines, wherein the method further comprises the steps of:
retrieving a list of counter values from each franking machine; and inserting the list of counter values, including the contents of an ascending and descending register, into a report created by the application program.

9. The method of claim 1 wherein at least one of the saved sequence of commands includes a command to initialize the franking machine.

10. The method of claim 9 wherein the command sets the franking machine ready for franking.

11. The method of claim 9 wherein the command configures the franking machine.

12. The method of claim 1 wherein the step of initiating one of the saved sequence of control commands further comprises the step of reading data directly into a document created by the application program.

13. The method of claim 1 wherein the control command is adapted to request statistical data from the franking machine and wherein when the data is returned to the franking machine the data is automatically entered in a document associated with the document application.

14. A system for controlling at least one franking machine comprising:
a computing device coupled to the at least one franking machine; and
an application program residing on the computing device, the application program adapted to allow a user to launch at least one saved sequence of commands that are linked to a franking machine control library in order to receive data from each franking machine and control a function of each franking machine.

15. The system of claim 14 wherein the saved sequence of commands comprises a series of macros, the macros being adapted to be launched by a single activation sequence.

16. The system of claim 15 wherein activation of one of the macros automatically generates a report on a state of the franking machines.

17. The system of claim 15 wherein the franking machine further comprises a postal security device.

18. The system of claim 14 wherein the franking machine is adapted to generate at least one postal indicia based on a control command generated by the computing device.

19. A computer program product comprising:
a computer useable medium having computer readable code means embodied therein for causing a computer to control an operation of a franking machine, the computer readable code means in the computer program product comprising:
computer readable program code means for causing a computer to open a document application program;
computer readable program code means for causing a computer to execute a saved sequence of control commands linked to a franking machine control library based on a command inputted by a user; and
computer readable program code means for causing a computer to execute a function at the franking machine corresponding to the command inputted by the user.

20. An article of manufacture comprising:
a computer useable medium having computer readable program code means embodied therein for causing a computer to control a franking machine from an office application, the computer readable code means in the article of manufacture comprising:
computer readable program code means for causing a computer to execute a sequence of control commands based on user generated input, the control commands adapted to execute a franking machines control function accessed from a franking machine control library; and
computer readable program code means for causing a computer to perform a function in the franking machine based upon the user input, wherein the franking machine is adapted to return data to the application responsive to the user input, and wherein the data is automatically uploaded into a document associated with the application.
